(19) United States
(12) Patent Application Publication
(10) Pub. No.: US 2018/0134999 A1
(43) Pub. Date: May 17, 2018

(54) COMPOSITIONS AND METHODS FOR MAKING NATURAL CLEANING PRODUCTS

(71) Applicant: Shecology, Inc., Weaverville, NC (US)

(72) Inventor: Mari Fox, Weaverville, NC (US)

(73) Assignee: Shecology, Inc., Weaverville, NC (US)

(21) Appl. No.: 15/354,770

(22) Filed: Nov. 17, 2016

(51) Int. Cl. C11D 17/04; C11D 3/382

(52) U.S. Cl. CPC C11D 17/046; C11D 3/382

(57) ABSTRACT

Compositions are provided for making natural cleaning products. The compositions can include a porous outer casing having a sealed inner portion containing drupes from Sapindus, rich in saponins. The saponins are a naturally-occurring surfactant and make a potent natural cleaner. The Sapindus can include or consist of Sapindus mukorossi. Methods of making a natural cleaning products are provided. The methods include steeping the compositions provided herein in water for a period of time sufficient to extract saponins from the Sapindus into the water. The compositions and methods provided herein can offer several advantages, including ease of storage and shipment to consumers and ease of making natural cleaning products.

### TECHNICAL FIELD

The present disclosure generally relates to compositions and methods for making natural cleaning products.

### BACKGROUND

Most commercially available cleaning formulations are also stored and shipped in liquid form in plastic containers. Liquid formulations are more costly to ship due to the increased weight associated with the liquid. Liquid formulations are also more difficult to store safely and to prevent leakage. Along with the expenses and difficulties of shipping and storing liquid cleaners, these cleaners are often packaged in plastic containers that, all too often, end up on landfills. Globally, more than 300 million tons of plastics are consumed annually, with polyethylene terephthalate (PET) being amongst the most common plastic for cleaner containers, and while PET is recyclable, the current production of PET bottles uses only about 5% of the recycled materials. Cleaners that avoid the need to ship and store the large quantities of liquid associated with commercially available cleaners and that do not require large plastic containers are desperately needed.

In addition to the above concerns, most commercially available cleaning formulations, such as those designed to efficiently clean industrial, domestic and/or communal hard surfaces and soft surfaces, have been created using an increasing number of synthetic surfactants and solvents. While such synthetically formulated cleaners can be extremely effective at killing germs and cleaning surfaces, they also pose a significant danger to the consumer and the local environment. These formulations often contain surfactants having various ionic charges, in particular surfactants that are non-ionic, anionic, cationic, or amphoteric in nature, acids, caustics, solvents, penetrating agents, oils, and/or alcohols. Many of these formulations, because they are not naturally occurring, can be hard on the environment as well as on the health and wellbeing of the user. Over time, the toxic effects of such compositions have become more widely known, and it has become desirable to attempt to avoid exposure to such toxic materials.

Because of these significant concerns posed by synthetic cleaners and the ever increasing desire for renewable resources, there has been an increased demand for entirely natural cleaning compositions. Plants of the genus Sapindus bear fruit in the form of small drupes rich in saponins, a naturally-occurring surfactant. The fruit are commonly referred to as soapnuts or soapberries, and the saponins they contain can be used to make a potent natural cleaner. Once the soapberries are collected, the saponins are traditionally extracted by boiling or steeping in water. After the saponins have been extracted, the residue and flesh of the soapberries still has to be removed from the cleaner, which typically requires a filtering step to remove the remains of the soapberries.

There remains a need for methods and compositions that overcome the aforementioned deficiencies.

### SUMMARY

Various compositions for making a natural cleaning product are provided that overcome the aforementioned deficiencies. The compositions can include a porous outer casing having a sealed inner portion containing the Sapindus. These compositions allow for easily making a natural cleaning product without the need to filter or extract the Sapindus drupes from the cleaner after steeping. On the commercial scale, the compositions also allow for ease of making the cleaning compositions by the consumer, which removes the need to store and to ship large volumes of liquid to the consumer.

A variety of compositions are provided including a porous outer casing having a sealed inner portion containing the Sapindus. The outer casing can include a porous paper, silk, or plastic casing. The Sapindus can be present in an amount of about 0.3 oz. to 0.5 oz, 0.3 oz. to 0.8 oz, or 0.3 oz. to 1.0 oz. A variety of species of Sapindus are known. The Sapindus can include Sapindus delavayi, Sapindus detergens, Sapindus emarginatus, Sapindus laurifolius, Sapindus marginatus, Sapindus mukorossi, Sapindus oahuensis, Sapindus rarak, Sapindus saponaria, Sapindus tomentosus, Sapindus trifoliatus, Sapindus vitiensis, or a combination thereof. In some embodiments, the Sapindus consists of or includes Sapindus mukorossi. The Sapindus can include the dried flesh of the Sapindus drupes that have been coarsely ground into an average particle size of about 10 mesh to 100 mesh, 30 mesh to 100 mesh, or 60 mesh to 100 mesh.

Methods of making a natural cleaning products are provided. The methods include steeping the composition provided herein in water for a period of time sufficient to extract saponins from the Sapindus into the water. In some aspects, the steeping can be performed for about 5 minutes to about 20 minutes. Although various volumes of cleaner may be made according to the methods, in some aspects the water is present in an amount from about 10 fluid ounces to about 40 fluid ounces. The steeping can generally be performed at any temperature sufficient to extract the saponins. In some regards, the temperature of the water is from about 70° C. to about 100° C. The methods can include removing the composition (i.e. removing the porous outer casing and the Sapindus in the sealed inner portion, from the water to leave an aqueous cleaner containing the saponins.

Other systems, methods, features, and advantages of compositions and methods for making a natural cleaning product will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A-1C depict a cross-sectional view (FIG. 1A), perspective view (FIG. 1B) and exploded view (FIG. 1C) of one embodiment of a composition for making a natural cleaning product.

FIGS. 2A-2C depict a cross-sectional view (FIG. 2A), perspective view (FIG. 2B) and exploded view (FIG. 2C) of one embodiment of a composition for making a natural cleaning product.

### DETAILED DESCRIPTION

In various aspects, compositions and methods for making a natural cleaner are provided. Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Compositions for Making Natural Cleaners

Various compositions for making a natural cleaning product are provided. The compositions can include a porous outer casing having a sealed inner portion containing Sapindus, rich in saponins. The saponins are a naturally-occurring surfactant and make a potent natural cleaner. These compositions allow for easily making a natural cleaning product without the need to filter or extract the Sapindus drupes from the cleaner after steeping. The compositions also allow for ease of making the cleaning compositions by the consumer, which removes the need to store and to ship large volumes of liquid to the consumer.

A variety of compositions are provided including a porous outer casing having a sealed inner portion containing the Sapindus. The outer casing can include a porous paper, silk, plastic, or fabric casing. In various embodiments, the pores in the outer casing should be small enough to prevent the Sapindus from escaping the sealed inner portion during steeping and to allow the composition to be easily removed from the water after steeping to extract the saponins into the water. Exemplary papers can include cellulose filter paper, ashless filter paper, nitrocellulose paper, glass microfiber filter paper, and polyethylene paper.

Sapindus is a genus of about five to twelve species of shrubs and small trees in the Lychee family, Sapindaceae, native to warm temperate to tropical regions. A variety of species of Sapindus are known. The Sapindus can include Sapindus delavayi, Sapindus detergens, Sapindus emarginatus, Sapindus laurifolius, Sapindus marginatus, Sapindus mukorossi, Sapindus oahuensis, Sapindus rarak, Sapindus saponaria, Sapindus tomentosus, Sapindus trifoliatus, Sapindus vitiensis, or a combination thereof. In some embodiments, the Sapindus consists of or includes Sapindus mukorossi. The Sapindus can include the dried flesh of the Sapindus drupes in a size large enough to not pass through the pores in the porous outer casing. The Sapindus can be coarsely ground into an average particle size of about 10 mesh to 100 mesh, 30 mesh to 100 mesh, or 60 mesh to 100 mesh.

The Sapindus can be present in any amount sufficient to make a natural cleaner when steeped. The amount present can depend upon the type of Sapindus used and the amount of saponins present. The Sapindus can be present in an amount from about 0.3 oz. to 0.5 oz, 0.3 oz. to 0.8 oz, or 0.3 oz. to 1.0 oz.

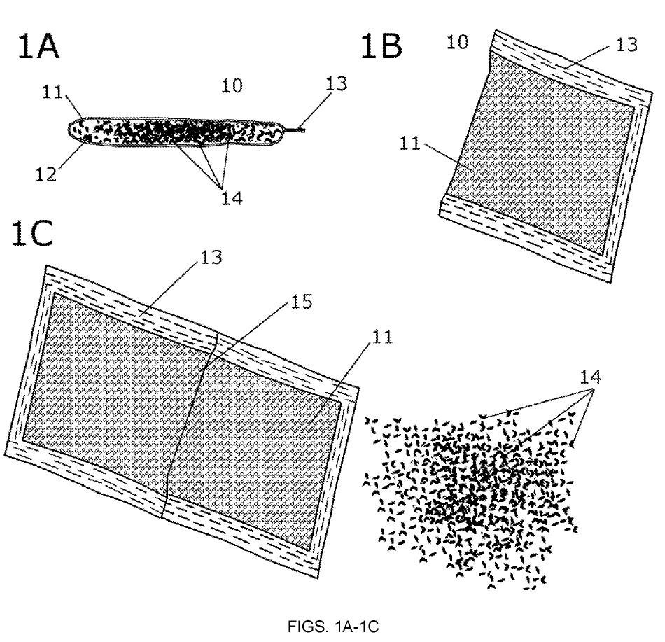

FIGS. 1A-1C depict an exemplary composition 10 for making a natural cleaning product. The composition 10 can include a porous outer portion 11 sealed along the edges 13 to form a sealed inner portion 12. The sealed inner portion 12 can contain the Sapindus 14. In some embodiments, where the porous outer portion 11 is formed of a single piece of porous paper, silk, or plastic casing, the porous outer portion 11 can be folded across a fold 15 to form the outer casing and then sealed along three edges 13 to form the sealed inner portion 12.

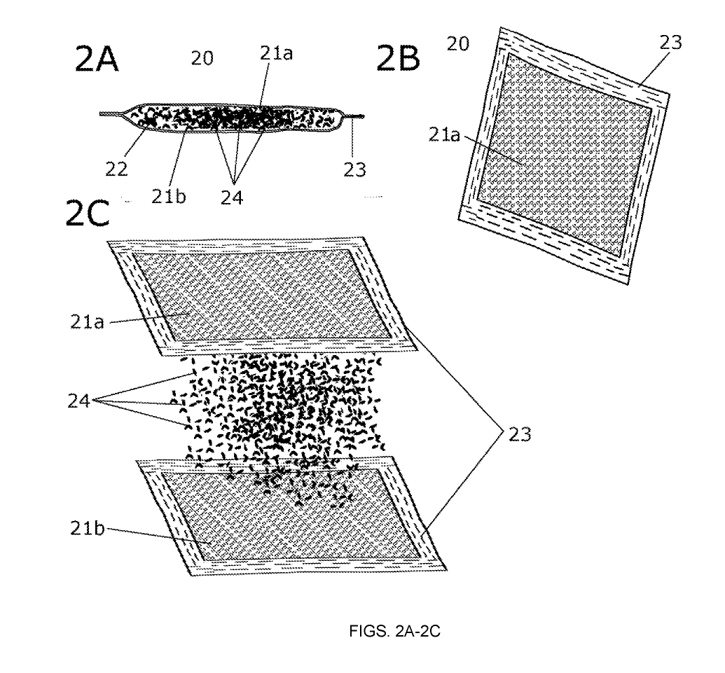

FIGS. 2A-2C depict an exemplary composition 20 for making a natural cleaning product. The composition 20 can include a porous outer portion 21 formed from an upper portion 21a and a lower portion 21 that can be sealed along the edges 23 to form the sealed inner portion 22. The sealed inner portion 22 can contain the Sapindus 24.

Methods of Making Natural Cleaners

Methods of making a natural cleaning products are provided. The methods include steeping any one of the compositions provided herein in water for a period of time sufficient to extract saponins from the Sapindus into the water. Because the cleaning product can be prepared by the consumer, there is no need to store and ship large volumes of liquid cleaning products that can be difficult to ship and prone to leakage.

In some aspects, the steeping can be performed for about 5 minutes to about 50 minutes, 5 minutes to about 20 minutes, 5 minutes to about 15 minutes, or about 7 minutes to about 15 minutes.

Although various volumes of cleaner may be made according to the methods, in some aspects the water is present in an amount from about 10 fluid ounces to about 40 fluid ounces per composition. In some aspects, more than one of the compositions can be used to make the desired volume of cleaning product.

The steeping can generally be performed at any temperature sufficient to extract the saponins. In some regards, the temperature of the water is from about 70° C. to about 100° C., 75° C. to about 95° C., or 80° C. to about 95° C. The methods can include removing the composition (i.e. removing the porous outer casing and the Sapindus in the sealed inner portion, from the water to leave an aqueous cleaner containing the saponins. Because the Sapindus remains encased in the sealed inner portion even after steeping to remove the saponins, the compositions make it easier for a consumer to make the cleaning products themselves.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1: Testing of Natural Cleaners from Sapindus Mukorossi

Solutions of Sapindus Mukorossi were prepared using varying concentrations of soap nut powder [including values of 0.55 g, 1.10 g, 2.20 g, and 4.40 g of soapnut powder] in 1 cup of warm (35° C.) water. The minimum inhibitory concentration (MIC) was determined as the lowest concentration of sample prepared that completely inhibits the growth of the organism as detected by the naked eye. The results are summarized in Table 1. The solutions were found to inhibit growth of Candida albicans, Aspergillus niger, Salmonella typhimurium, Escherichia coli, and Staphylococcus aureus.

TABLE 1
Minimum Inhibitory Solutions Prepared from Varying
Amounts of Soap Nut Powder in 1 cup of water

| Organism | MIC (mass soap nut powder per 1 cup) |
|---|---|
| Aspergillus niger | 1.10 g |
| Candida albicans | 0.55 g |
| Escherichia coli | 4.40 g |
| Salmonella typhimurium | 2.20 g |
| Staphylococcus aureus | 4.40 g |

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A composition for making a natural cleaning product, the composition comprising a porous outer casing having a sealed inner portion comprising Sapindus.

2. The composition of claim 1, wherein the Sapindus is present in an amount of about 0.3 oz. to 0.5 oz.

3. The composition of claim 1, wherein the Sapindus is selected from the group consisting of Sapindus delavayi, Sapindus detergens, Sapindus emarginatus, Sapindus laurifolius, Sapindus marginatus, Sapindus mukorossi, Sapindus oahuensis, Sapindus rarak, Sapindus saponaria, Sapindus tomentosus, Sapindus trifoliatus, Sapindus vitiensis, and a combination thereof.

4. The composition of claim 1, wherein the Sapindus consists of the dried flesh of the Sapindus drupes that has been coarsely ground into an average particle size of 10 mesh to 100 mesh.

5. The composition of claim 1, wherein the porous outer casing comprises a porous paper, silk, plastic, or fabric casing.

6. The composition of claim 1, wherein the Sapindus comprises Sapindus mukorossi.

7. The composition of claim 6, wherein Sapindus mukorossi is present in an amount of about 0.3 oz. to 0.5 oz.

8. The composition of claim 6, wherein the Sapindus mukorossi consists of the dried flesh of the Sapindus mukorossi drupes that has been coarsely ground into an average particle size of 10 mesh to 100 mesh.

9. The composition of claim 6, wherein the porous outer casing comprises a porous paper, silk, or plastic casing.

10. A method of making a natural cleaning product, the method comprising steeping the composition of claim 1 in water for a period of time sufficient to extract saponins from the Sapindus into the water.

11. The method of claim 10, wherein the steeping is performed for a period of time from about 5 minutes to about 20 minutes.

12. The method of claim 10, wherein the water is present in an amount from about 10 fluid ounces to about 40 fluid ounces.

13. The method of claim 10, wherein the water is at a temperature from about 70° C. to about 100° C.

14. The method of claim 10, wherein the Sapindus is present in an amount of about 0.3 oz. to 0.5 oz.

15. The method of claim 10, wherein the Sapindus is selected from the group consisting of Sapindus delavayi, Sapindus detergens, Sapindus emarginatus, Sapindus laurifolius, Sapindus marginatus, Sapindus mukorossi, Sapindus oahuensis, Sapindus rarak, Sapindus saponaria, Sapindus tomentosus, Sapindus trifoliatus, Sapindus vitiensis, and a combination thereof.

16. The method of claim 10, wherein the Sapindus consists of the dried flesh of the Sapindus drupes that has been coarsely ground into an average particle size of 10 mesh to 100 mesh.

17. The method of claim 10, wherein the porous outer casing comprises a porous paper, silk, or plastic casing.

18. The method of claim 10, wherein the Sapindus comprises Sapindus mukorossi.

19. The method of claim 18, wherein Sapindus mukorossi is present in an amount of about 0.3 oz. to 0.5 oz.

20. The method of claim 18, wherein the Sapindus mukorossi consists of the dried flesh of the Sapindus mukorossi drupes that has been coarsely ground into an average particle size of 10 mesh to 100 mesh.
